(19) United States
(12) Patent Application Publication
(10) Pub. No.: US 2011/0073254 A1
(43) Pub. Date: Mar. 31, 2011

(54) Method of decorative window enhancement

(76) Inventor: Dennis Sibley, Bristol, PA (US)

(21) Appl. No.: 12/586,644

(22) Filed: Sep. 25, 2009

(51) Int. Cl. B32B 37/12

(52) U.S. Cl. 156/297

(57) ABSTRACT

A method of decorative window enhancement uses an elongated lead strip which has lateral indentations extending the length of the strip. A high bond adhesive is applied to the bottom surface of the central section of the lead strip. The lead strip is then placed on a glass surface where pressure is exerted on the strip to bond the strip to the surface. The lateral indentations of the lead strip are formally filled with stain glass putty which is permitted to dry fully in the indentations between the strip and the glass surface. This technique is used with multiple lead strips to form an enhanced, dramatic pattern on the glass surface.

### BACKGROUND OF THE INVENTION

The present invention relates to a method of decorative window enhancement and, specifically, to providing window panes which simulate the look and character of leaded glass windows with Old English or similar patterns.

Traditional leaded glass windows consist of individual panes of glass fastened together by thin, grooved lead rods or similar soft metal rods known as “cames” which are usually soldered together. The cames form patterns into which the panes of glass are secured. These types of windows have been used for hundreds of years in churches, cathedrals, government buildings, manor houses, and palaces, but are still very popular in commercial buildings and private residences.

However, such leaded glass windows are very costly to produce since they are handmade, requiring skilled labor. In addition, the windows are inherently weak and over time the seal between the glass and lead cames deteriorates, which allows water to seep through the window. These types of decorative windows also cannot be used on many structures because certain building codes require the use of safety glass windows.

To address these disadvantages, a number of decorated window techniques have been developed which attempt to convert the appearance of standard existing panes of glass to leaded glass windows. However, few have successfully incorporated the desired, realistic appearance of patterned lead glass window, with the ease and economy of its manufacture.

### SUMMARY OF THE INVENTION

The present invention comprises a method of decorative window enhancement which not only produces a simulated decorative glass window which has the realistic dramatic appearance and beauty of a traditional leaded glass window appearance, but also overcomes the current difficulties and expense of its manufacture. The decorative window method of the invention can be used on a continuous sheet of tempered or similar safety glass. The resulting window enhancement is also weatherproof. In addition, the method allows for a variety of ornamental window patterns.

These and other advantages of the invention are accomplished by the present method of decorative window enhancement. An elongated lead strip is provided which has lateral indentations extending the length of the strip. A high bond adhesive is applied to the bottom surface of the central section of the lead strip. The lead strip is then placed on a glass surface where pressure is exerted on the strip to bond the strip to the surface. The lateral indentations of the lead strip are formally filled with stain glass putty which is permitted to dry fully in the indentations between the strip and the glass surface. This technique is used with multiple lead strips to form an enhanced, dramatic pattern on the glass surface.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows an example of a decorative window which employs the prior art technique for bonding lead strips to glass.

FIG. 2 is a cross-section of a prior art lead strip.

FIG. 3 is a cross-section of a prior art lead strip attached to glass.

FIG. 4 is a cross-section of the lead strip used in the method of the present invention.

FIG. 5 is a cross-section of the lead strip used in the present invention attached to glass in accordance with the method of the invention.

FIG. 6 depicts the steps of the method of the present invention.

FIG. 7 shows an example of a decorative window employing the enhancement of the method of the present invention.

FIG. 8 is a cross-section of an alternate lead strip used in the method of the present invention.

FIG. 9 is a cross-section of the lead strip in FIG. 8 attached to glass in accordance with the method of the present invention.

### DETAILED DESCRIPTION OF THE INVENTION

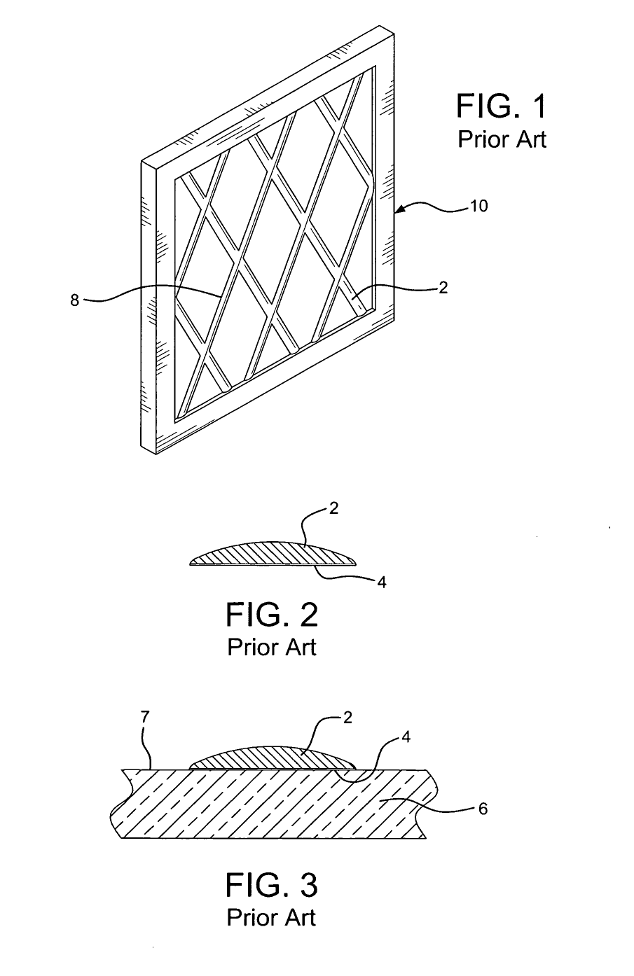

FIG. 1 shows an example of decorative window 10 using the prior art technique which bonds a lead strip onto a glass or plastic surface. Soft metal strip 2 made of lead alloy or similar soft metal, has a standard oval profile. See FIG. 2. A transfer adhesive 4 is placed between lead strip 2 and the surface of glass 6, employing lead strips 2 in a diamond pattern 8 which creates in decorative window 10.

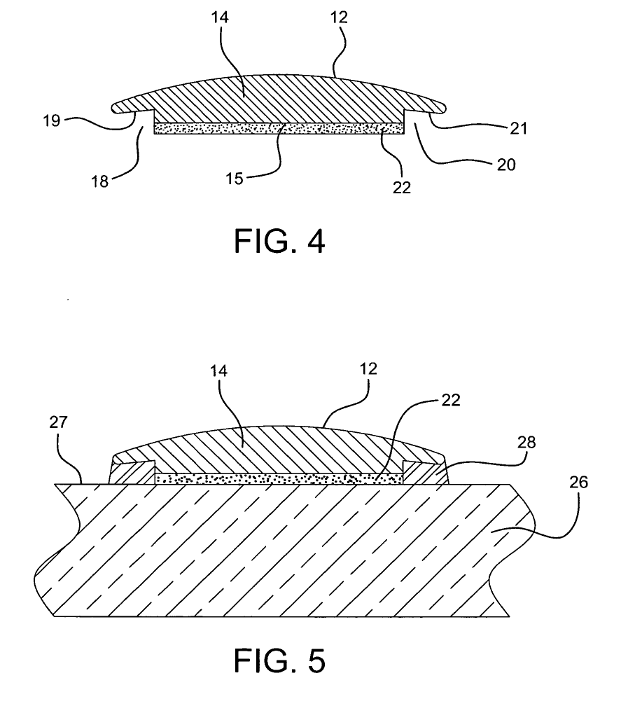

The method of the present invention results in an enhanced decorative window with a more dramatic appearance. As shown in FIGS. 4 and 5, elongated lead alloy strip 12, unique in configuration to the method of the present invention, comprises an alternate oval profile with central section 14 having bottom surface 15, central section 14 being bordered by laterally extending indentations 18 and 20. These indentations extend for the entire longitudinal length of lead strip 12. A special high bond adhesive 22 and stain glass putty 28 are also used.

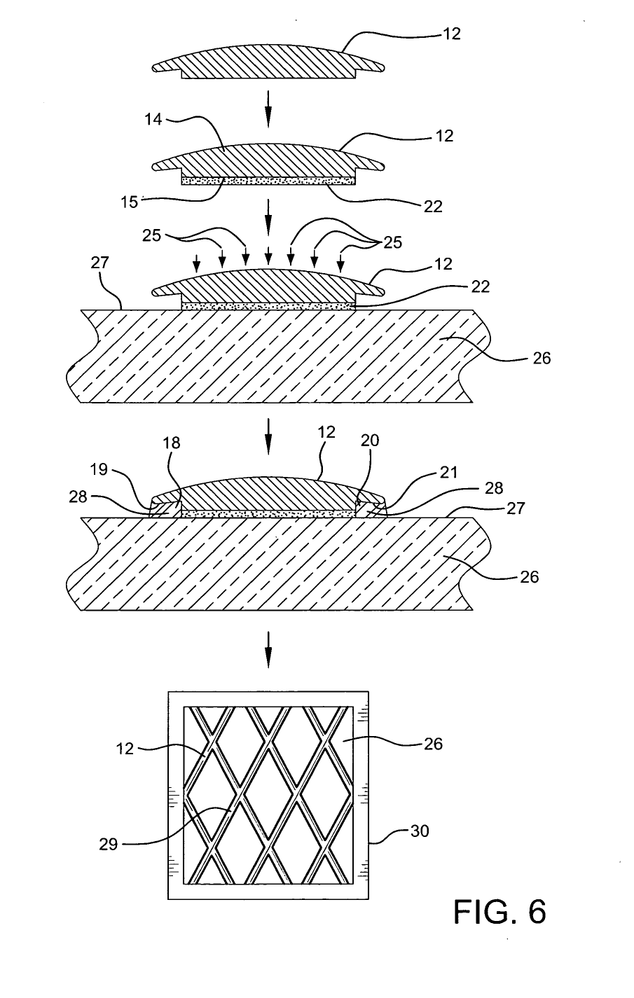

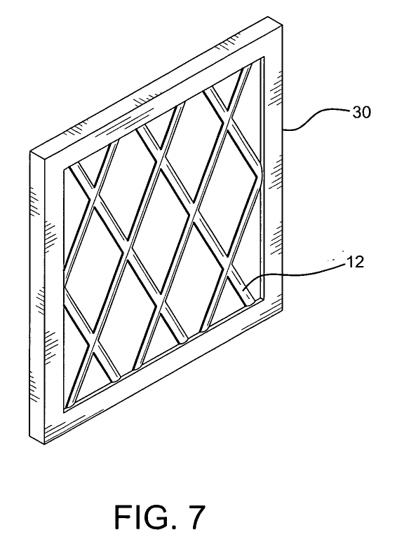

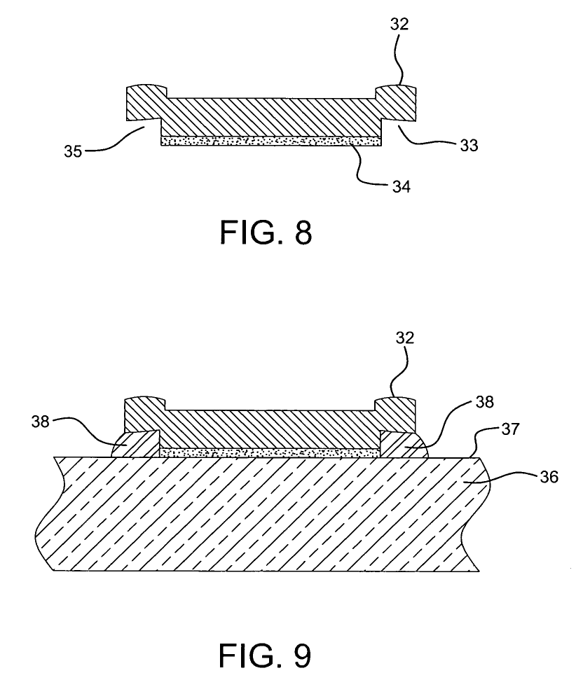

The method of the present invention, as best depicted in FIG. 6, provides for lead strip 12. Adhesive 22 is applied to bottom surface 15 of central section 14 of lead strip 12. Lead strip 12 is then placed on surface 27 of glass 26 and pressure 25 is exerted on the strip to bond it to the glass surface. Once lead strip 12 is securely bonded to glass surface 27, indentations 18 and 20 are filled with a stain glass putty 28. Stain glass putty 28 is inserted uniformally along the full length of lead strip 12, between bottom surfaces 19 and 21 of indentations 18 and 20 and glass surface 27. The stain glass putty 28 is allowed to sufficiently dry. A plurality of elongated lead strips 12 are bonded to glass surface 27 in this manner to form the desired pattern 29.

The result is an upstanding lead strip 12 with exposed stain glass putty 28 which provides a dramatic effect on glass surface 27. When arranged in a pattern, as seen in FIGS. 6 and 7, the decorative window enhancement method of the present invention results in window 30 having an enhanced and more attractive decorative window pattern.

FIG. 8 is an example of an alternative lead strip which can be applied to a glass surface, with different effect. Lead strip 32, with indentations 33 and 35, is also configured to be positioned on surface 37 of glass 36. Bonding adhesive 34 and stain glass putty 38 are employed in the same manner as previously described with regard to the first embodiment.

While the configurations of two exemplar lead strips 12 and 32 are disclosed, it is contemplated that other strips of different designs and configurations can be employed and the invention, as described herein, should not be considered restricted to the two designs specifically discussed.

Thus, the method of decorative window enhancement of the present invention provides decorative windows which accurately and realistically simulate the leaded glass windows of the past while materially enhancing the beauty of plain windows and those which employ existing decorative techniques. The method is relatively simple to properly accomplish and is economical in its manufacture.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A method of decorative window enhancement comprising the steps of:
providing an elongated lead strip having a central section with a bottom surface extending substantially the length of the lead strip, and lateral indentations with bottom surfaces extending substantially the length of the lead strip;
applying a high bond adhesive to the bottom surface of the central section of the lead strip;
placing the lead strip on a glass surface;
exerting pressure on the lead strip to bond said lead strip to the glass surface;
filling stain glass putty into the lateral indentations of the lead strip, between the bottom surface of the indentations and the glass surface;
distributing the stain glass putty uniformally within the indentations, such that the indentations are completely filled with said stain glass putty along the full length of the lead strip;
allowing the stain glass putty to fully dry within the indentations; and
forming an upstanding, raised decorative strip on the glass surface.

2. The method as in claim 1 comprising the step of providing a plurality of elongated lead strips having central sections with bottom surfaces extending substantially the lengths of the lead strips.

3. The method as in claim 2 wherein each of the plurality of lead strips is attached to the glass surface in accordance with the steps in claim 1 to form a pattern on the glass surface.
